(19) United States
(12) Patent Application Publication
(10) Pub. No.: US 2014/0013828 A1
(43) Pub. Date: Jan. 16, 2014

(54) METHOD AND APPARATUS FOR TESTING THE SEAL OF A JUNCTION LINER

(71) Applicant: LMK Technologies, LLC, Ottawa, IL (US)

(72) Inventor: Larry W. Kiest, Jr., Ottawa, IL (US)

(73) Assignee: LMK Technologies, LLC, Ottawa, IL (US)

(21) Appl. No.: 13/783,445

(22) Filed: Mar. 4, 2013

Related U.S. Application Data
(60) Provisional application No. 61/671,913, filed on Jul. 16, 2012.

(51) Int. Cl. G01M 3/22

(52) U.S. Cl. CPC G01M 3/223
USPC 73/40.7

(57) ABSTRACT

A method and apparatus for testing the seal of a junction liner assembly is provided. The liner assembly includes a main liner member and a lateral liner tube extending from the main liner member. The lateral liner is attached to the main liner. To determine if there is a leak in the assembly, the assembly is placed on a plate with perforations. A negative pressure source pulls the liner assembly tightly against the plate. A colored liquid is applied to the liner assembly under the negative pressure. The assembly is then viewed to determine if any of the colored liquid has passed through the liners, which would indicate a leak in the assembly. The leak is repaired, and the assembly is then retested with a different color to test for any additional leaks.

### CROSS-REFERENCE TO RELATED APPLICATIONS

This application claims priority under 35 U.S.C. §119 to provisional application Ser. No. 61/671,913, filed Jul. 16, 2012, which is herein incorporated by reference in its entirety.

### FIELD OF THE INVENTION

The present invention relates generally to the field of quality testing processes and materials for the manufacture of coated textiles or related items. More particularly, but not exclusively, the invention relates to a method and apparatus for testing the seal of a liner used to repair a junction between a main and lateral pipe.

### BACKGROUND OF THE INVENTION

One method of repairing the junction between main and lateral sewer pipelines is shown in U.S. Pat. No. 6,039,079, which is hereby incorporated in its entirety. A liner assembly, as shown in FIG. 3 of the '079 patent, includes a lateral liner 26 connected to a flat sheet liner 28. Both liners 26, 28 are formed of felt or other resin absorbent material. The resin is absorbed into both liners in an uncured state and the liners are held in place in the host pipelines as the resin is cured and hardened to form a hardened liner. The liners also generally include a coated film or other impermeable layer on one side, with the other side comprising the felt or other resin absorbent material.

The lateral liner 26 is formed by connecting side edges of a sheet of liner material with a polymer coating 20 on the exterior side. The edges are sewn together at a seam and a strip of polymer tape 34 is welded over the seam to form an airtight seal. The flat sheet liner 28 includes a central aperture therein and the liner is sewn to one end of the lateral liner 26 around the aperture. Then, a strip of polymer tape 38 is folded along its length and welded continuously around the junction to form an airtight seal. In addition, other means, such as flame bonding, stitching, gluing, or the like may be used to attach the lateral liner to the flat sheet liner.

It is important that the lateral liner and the flat sheet be sealed at an impermeable coated side, such that resin is not able to leak during repair of the pipe junction. Therefore, the seal needs to be tested after the lateral liner and flat sheet have been combined to determine if there are any leaks. Prior leak tests have included air testing and soap testing. With air testing, air is blown through one side of the liner, and the opposite side is monitored to determine if air can be felt leaking through. However, if air does leak through, it is often difficult to determine the exact location of the leak. All that is felt is air passing through the liner. The air testing also has been proven to be destructive to the liner because it promotes delamination of the coated film or seal from the fabric material.

Bubble testing also has limitations. With bubble testing, the liner is coated in soapy water and the leaks can be determined to be where the bubbles are forming. However, often many bubbles are formed and it is very difficult to pinpoint the exact location of a leak. Additionally, when soapy water is sprayed onto the liner, the soap hinders any attempt to repair the leak.

Therefore, there is a need in the art for an improved method for testing the seal between a lateral liner and a main liner member that provides quick and accurate results, without affecting the integrity of the liner assembly.

### SUMMARY OF THE INVENTION

Therefore, it is principal object, feature, and/or advantage of the present invention to provide an apparatus that overcomes or improves the deficiencies in the art.

Another object, feature, and/or advantage of the present invention is to provide a method and means of testing a liner assembly used to repair the junction of a main and lateral pipe for leaks.

It is another object, feature, and/or advantage of the present invention to provide a repeatable method for testing the seal of a main and lateral pipe connection.

It is yet another object, feature, and/or advantage of the present invention to provide a test for leaking in a liner assembly that will provide exact locations of leaks.

It is still a further object, feature, and/or advantage of the present invention to provide a method and means that will result in new indication of whether the leak has been sealed in a liner assembly.

These and/or other objects, features, and advantages of the present invention will be apparent to those skilled in the art. The present invention is not to be limited to or by these objects, features and advantages. No single embodiment need provide each and every object, feature, or advantage.

One aspect of the present invention relates to a method for testing the seal between a lateral liner and a main liner member for lining a junction. The method includes taking a liner assembly comprising a main liner member having a main liner member opening therein, and a lateral liner extending from the main liner member opening. The liners are attached to one another at the main liner member opening. Colored water is dispensed on a coated side of the liner assembly, and a vacuum is turned on to create negative pressure on the opposite side. The vacuum is turned off and the uncoated side of the liner assembly is viewed to determine if any of the colored water has leaked through.

The location of any leaked, colored water indicates a leak in the liner assembly, which can be fixed before the liner is used to repair the junction of a pipe. Once the leak has been resealed, a different colored water is dispensed on the coated side of the liner assembly, the vacuum is turned on to create negative pressure on the opposite side, and then the assembly is turned over to determine if any of the new color of water has leaked through the assembly. If so, the location of the leak will be noted by the location of the new color of dye in the water, and the process can be repeated with a new, different color of dyed water. If the test reveals no leaks in the liner assembly, the lateral and main liners have been properly sealed, and the assembly is ready to be used in the field to repair the junction of a main and lateral liner.

The apparatus to test the seal of the junction liner assembly can be a flat plate with apertures or perforations therethrough. The plate is hooked up to a vacuum source pulling a significant negative pressure at about 28 inches of Hg; such negative pressure is experienced on the opposite side of the plate from the vacuum.

### BRIEF DESCRIPTION OF THE DRAWINGS

FIG. 1 is a perspective view of the main/lateral liner assembly having an adhesive applied to the junction between the main and lateral portions of the liner.

FIG. 2 is a sectional view of a testing apparatus according to the present invention that is used to test the liner assembly of FIG. 1 for leaks.

### DETAILED DESCRIPTION OF THE PREFERRED EMBODIMENTS

The present invention relates to a method and apparatus for testing the seal of a liner assembly that is used to repair the junction of a main and lateral pipe. The liner assembly comprises a main liner member and a lateral liner tube. The main liner member may be a flat sheet, a circle, or another shape, and the lateral liner may be formed from a flat sheet with its ends attached to one another to form a tube. One method for forming the liner assembly is shown and described in U.S. application Ser. No. 12/832,602, which is hereby incorporated in its entirety.

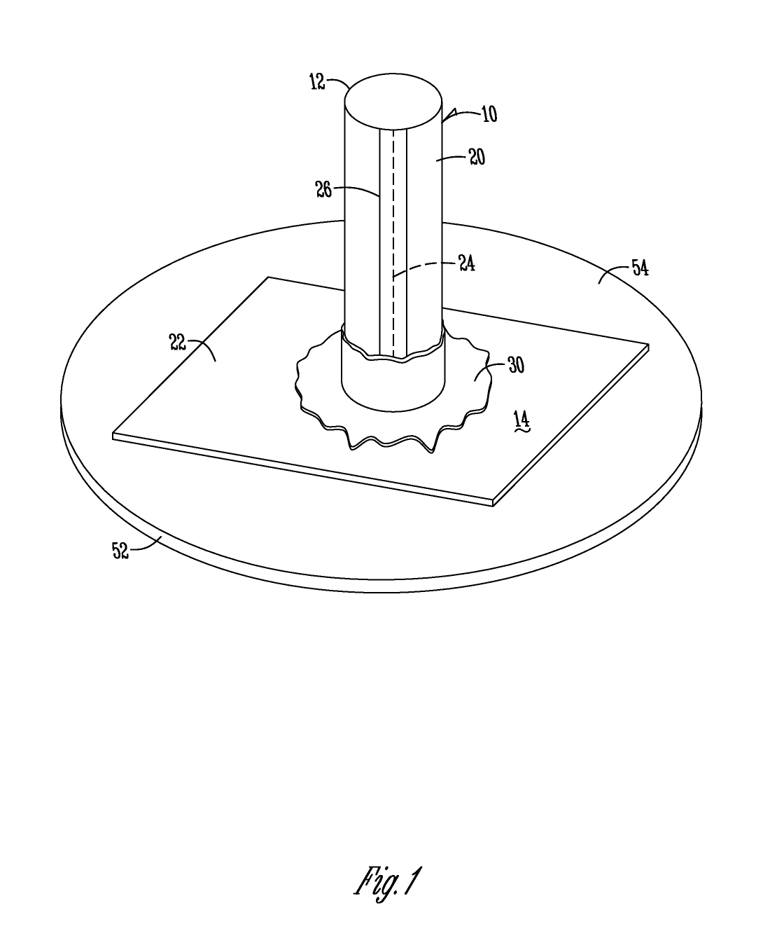

Referring to FIG. 1, a main/lateral liner assembly 10 is shown made of a felt or other material that can be impregnated with a curable and hardenable material. The liner assembly 10 includes a lateral liner 12 and a main liner member 14. The main liner 14 preferably starts as a flat sheet liner and is formed into a cylinder (not shown) prior to installation. The main liner member 14 preferably forms a tubular shape for installation, but a main liner member 14 formed as a rim or collar can also be used.

The lateral liner 12 is formed into a cylinder or other shape that fits a main liner member opening 16 in the main liner member 14. The lateral liner 12 is then stitched in a line of stitching 24 to conform to its cylindrical or other shape, and a polymer tape 26 is adhered or welded over the stitches to create an airtight seal. Other adhesives, including resins, epoxies, and the like could also be used to create the seal of the lateral liner 12.

The lateral liner 12 is then attached to the main liner member 14 with stitches 18 that extend through the aperture 16 in the main liner member 14. It should also be noted that the exterior of the lateral liner 12 comprises a resin impermeable coating 20, and the upper horizontal surface of the main liner member 14 also comprises a resin impermeable coating 22. It is preferred that the resin impermeable coating is a polymer, but other compositions having similar characteristics may be used as well. The lateral liner 12 is stitched or otherwise attached to the main liner member 14 with the coating sides 20, 22 both on the exterior. The interior of the tubed lateral liner 12 and the bottom side of the main liner member 14 comprise a material that is suitable to soak up and absorb a resinous material capable of curing and hardening. An example of such an absorbent material is felt, or a felt-like material. The resin impermeable coatings 20, 22 on one side of the lateral liner 12 and the main liner member 14 create an airtight seal that does not allow the resinous material, or air, to penetrate therethrough. However, because the liner assembly 10 is produced from two separate pieces and stitched together, the juncture of the lateral liner 12 and the main liner member 14 may not be airtight. An adhesive is added to supplement the juncture to produce a pliable, airtight seal 30 between the coating side 20 of the lateral liner 12 and the coating side 22 of the main liner member 14. The adhesive is applied directly to the coatings 20, 22 to seal any gap between the two coatings, while not affecting the absorbent material. The adhesive may be a thermoset adhesive, a UV or light-curing adhesive, a pressure-sensitive adhesive, a contact adhesive, or a drying adhesive. Preferably, a liquid UV curing adhesive is used to provide an excellent bond while decreasing labor and manufacturing costs. Alternatively, a tape, a resin, a patch, or other sealing means may be utilized to provide seal 30.

It should also be appreciated that other methods and means of combining the lateral liner 12 and main liner member 14 could be used. For example, flame bonding, stitching, gluing, taping, welding, or other methods could be used to combine the liners 12, 14. While the preferred method is stitching and sealing the connection with an adhesive, the present invention is not to be limited to any one method of combining the liners to form the liner assembly 10. However, the connection needs to be sealed to ensure the fluid-tightness of the connection area such that the resin or fluids are not able to pass through the seal 30, which would affect the structural integrity of the repaired pipe junction.

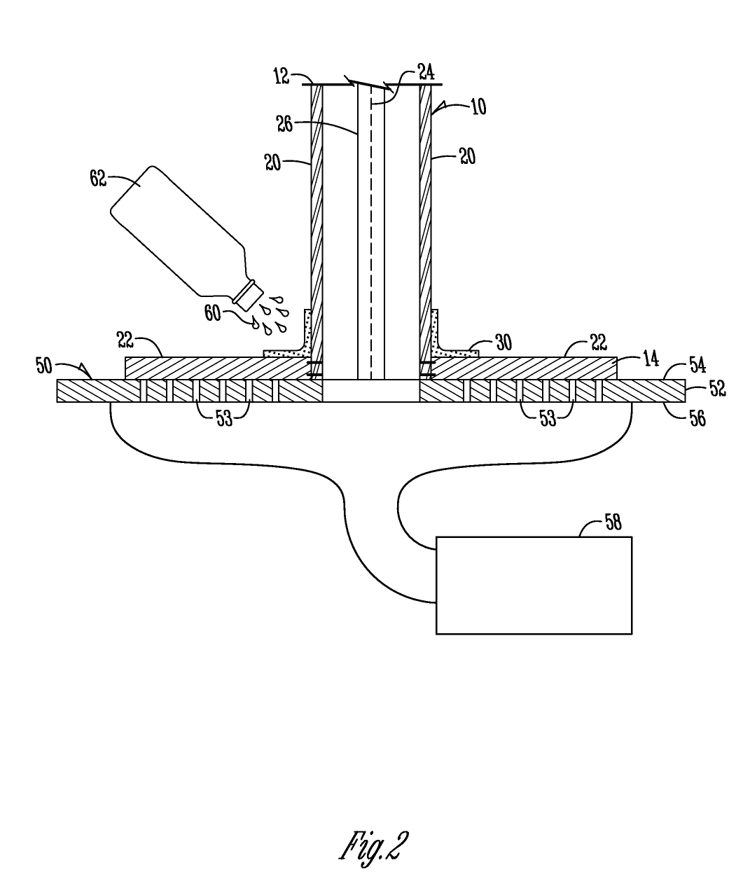

Therefore, FIG. 2 of the present invention shows a method of testing the seal 30 at the area where the lateral liner 12 and the main liner 14 are attached to one another. The method includes the use of a tester or testing apparatus 50. The tester 50 includes a plate 52 with a plurality of perforations or apertures 53 extending from a top side 54 to a bottom side 56 of the plate 52. The plate 52 may comprise metal, plastic, or generally any other rigid material capable of including the perforations and also capable of supporting the liner assembly 10 for testing.

The tester 50 also includes a negative pressure source 58 operatively attached to the bottom side 56 of the plate 52, such as by sealing a hose to the bottom side of the plate 52 and connecting the hose to a vacuum. The negative pressure source 58 is configured to be attached at the perforations such that turning on the source 58 creates an area of negative pressure at the top side 54 of the plate 52 and around the perforations. Thus, the source provides suction at the top side 54 of the plate 52. The negative pressure source 58 may be a vacuum or vacuum source. It is contemplated that the negative pressure be in the range of 10-40 inches of Hg. More preferred is the range of 20-30 inches of Hg. It is even more preferred that the vacuum include negative pressure at approximately 28 inches of Hg. However, other amounts of negative pressure may work with the present invention. It should be noted that the tester 50 may alternatively comprise a vacuum hose capable of providing a negative pressure to at least a portion of the seal 30.

Once the liner assembly 10 has been formed, it can be moved to the tester 50. The liner assembly 10 is placed on the tester 50 with the resin absorbent side of the main liner member 14 being placed on the top side 54 of the plate 52, and the lateral liner 12 extending generally away from the plate 52. Thus, the coating sides 20, 22 of the liners will be on the exterior of the liner assembly 10. The negative pressure source 58, or vacuum, is turned on to create the negative pressure at the bottom side 56 and top side 54 of the plate 52. The negative pressure causes the liner assembly 10 to be pulled tightly against the plate 52.

A colored liquid 60, such as water combined with a food dye, is dispensed at the seal 30 of the liners 12, 14. The water may be combined with the food dye or other coloring means in a bottle 62 or other apparatus to allow the water to be dispensed easily and in a controlled manner from the apparatus. The color should be selected such that it will stand out and be noticeable against the color of any of the aspects of the liner assembly 10. Any excess amount of liquid 60 can be wiped off or otherwise removed from the assembly. The negative pressure source 58 is allowed to operate for an amount of time after the liquid 60 has been added to the coating sides 20, 22 of the liner assembly 10. The source 58 is then turned off, which releases the liner assembly 10 from the plate 52.

The liner assembly 10 is positioned to view the resin absorbent sides 21, 23 of the lateral and main liners 12, 14. If there is a leak at the connection or seal, the leak is easily identified by staining of the fabric in the color of the food coloring or other coloring source. The location of any staining will also designate the location of said leak. If the assembly has been fully sealed, there will be no staining or coloring on the fabric or resin absorbent side of the liner assembly 10, and the assembly is considered to be ready to use in the field to repair the junction of one or multiple pipes, such as the junction between a main and lateral sewer pipe. However, if the testing indicates that there is a leak in the connection between the main and lateral liners 14, 12, the assembly 10 must be resealed before being used in the field. The leak would allow fluids to pass through the assembly 10, which could affect the integrity of the repair of the pipe junction. Therefore, the location of the leak is noted by the location of the stain or dye color on the resin absorbent side of the liners. The assembly 10 is resealed, particularly at the location of the leak, with an adhesive, a tape, a resin, a patch, or other sealing means. The entire connection location of the assembly can be resealed, or the exact location only of the leak can be resealed. The assembly can be taken back to be repaired and there is nothing on the surface that would hinder the adhesive from attaching to the liners. In other words, the water/color mixture will not hinder the repair of the seal. The assembly 10 is then repositioned at the tester 50 to again check to determine if there are any other leaks, new or unrepaired, in the seal 30 or anywhere else in the coating of the assembly 10. For the second test, a different colored liquid should be used so as to not confuse the prior leak(s) with any potential new leak(s) that may exist.

The resealed assembly 10 is then tested in the same manner as before. The assembly is placed on the tester 50 with the resin absorbent side of the liners facing the top side 54 of the plate 52. The negative pressure source 58 (vacuum source) is turned on to pull the liner assembly 10 against the plate. The different colored liquid is applied or dispensed on to the coated sides 20, 22 of the assembly while the negative pressure is acting on the assembly 10. The negative pressure source 58 is turned off, and the assembly is viewed to view the resin absorbent side of the liners 12, 14. The assembly is then examined to determine if any of the second colored liquid has passed to the resin absorbent side, which would indicate additional leaks in the assembly 10. If the new color of liquid is not found, the leaks have been sealed, and the liner assembly 10 is now ready to be used in the field to repair the junction of a main and lateral pipe. However, if the second color of liquid is found on the resin absorbent side of the liner assembly 10, this indicates that there are additional leaks that need to be resealed before using the assembly. The assembly is resealed, particularly at the location of the additional leaks, and the assembly is then retested at the tester 50 using a third colored liquid. The process is repeated with this third color to ensure that all of the leaks of the assembly have been properly sealed.

The method of the present invention is repeated until the test indicates that there are no more leaks in the seal 30 or coatings 20, 22 of the liner assembly 10. Thus, the present invention contemplates that the number of tests to determine if the assembly includes leaks is as many as required. In addition, the present invention prefers that a new color of liquid be used with each subsequent test on one liner assembly 10 so that the it can easily be determined if leaks occur. However, the present invention also contemplates that any number of colors be used, even the use of one color for multiple tests of the same assembly 10.

The present invention provides many advantages over prior methods of testing the assemblies. The invention does not cause the coatings 20, 22 to become delaminated from the resin absorbent material during testing. The use of a colored liquid, such as water, along with negative pressure, also does not prevent additional sealant to be added to the assembly to repair any leaks. The invention provides a quick and easy testing method and apparatus that can quickly provide a user with notice of the need for any repairs prior to placing the liner assembly 10 in the field.

Furthermore, it is to be appreciated that the method of testing as shown and described could be used to test generally any seal. For example, as mentioned above, a liner tube 12 can be formed by taking a sheet of material and connecting it edges, such as by stitching. A polymer tape 24 or other means is used to seal the connected edges. However, to ensure that the edges are fluidly sealed, the liner tube 12 alone could be operatively connected to the tester 50, and a colored fluid provided along the seal of the edges of the liner tube to make sure that the edges are fluidly sealed to one another. The colored fluid would be added to the impermeable coating side 20 of the liner tube 12, and the resin-absorbent side can be viewed after an amount of time under negative pressure to see if there have been any leaks, and to pinpoint the location of the leaks. This would allow the liner tube to be fluidly sealed prior to use in repairing a pipe.

It is further contemplated that the method and means of testing the seal can be used with generally any construction process where two edges and/or components are attached to one another to provide a fluid-tight seal between the connections. It is contemplated that any assembly could be positioned on the tester 50 of the present invention, colored fluid applied to the assembly, and the negative pressure provided to determine if there are any leaks in the assembly, and if so, the exact location of the leaks. The process can be repeated until all of the leaks have been properly sealed such that the item or assembly can then be used for its intended purpose, e.g., repairing a conduit.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of testing a liner assembly used to repair the junction of a main and lateral pipe, comprising:
providing a liner assembly comprising a main liner member having a main liner member opening and a lateral liner tube attached at and extending from the main liner member opening, the liners comprising a resin absorbent side and a coated side;
positioning the liner assembly on a tester adapted to provide a negative pressure to the liner;
dispensing a colored liquid to the coated side of the liner assembly; and
viewing the resin absorbent side of the liner assembly to determine if the colored liquid has passed through to indicate a leak in the liner assembly.

2. The method of claim 1 further comprising resealing the liner assembly at a leak if the test indicates that a leak exists.

3. The method of claim 2 further comprising repeating the test with a different colored liquid after resealing the liner assembly until no leaks exist in the liner assembly.

4. The method of claim 1 wherein the coated side of the liners comprises an impermeable material.

5. The method of claim 1 wherein the negative pressure source is a vacuum.

6. The method of claim 1 wherein the liner assembly is formed by a method comprising:
taking a liner tube having a first end, an opposite second end, and a resin impermeable coated liner tube surface opposite a resin absorbent liner tube surface;
taking a liner member having an aperture therein, and resin impermeable coated liner member surface opposite a resin absorbent liner member surface;
joining the first end of the liner tube to the liner member about the aperture in the liner member;
applying a liquid adhesive around a junction formed between the resin impermeable coated liner tube surface and the resin impermeable coated liner member surface; and
curing the adhesive.

7. The method of claim 1 wherein the lateral liner is attached to the main liner member by flame bonding, stitching, gluing, or taping.

8. The method of claim 1 wherein the tester comprises a plate with perforations therethrough and a negative pressure source operatively attached to the plate.

9. The method of claim 8 wherein the step of positioning the liner assembly on a tester further comprises positioning the liner assembly with the resin absorbent side of the liners positioned adjacent the plate.

10. The method of claim 1 further comprising shutting off the negative pressure source and turning the liner assembly over prior to viewing the resin absorbent side of the liners.

11. An apparatus for testing the seal of a liner assembly used to repair the juncture of main and lateral pipe, comprising:
a plate comprising a top side and opposite bottom side and a plurality of perforations therethrough; and
a negative pressure source operatively attached to one of said top or bottom sides of the plate and configured to create a negative pressure on the opposite of said top or bottom side.

12. The apparatus of claim 11 wherein the negative pressure source is a vacuum.

13. The apparatus of claim 11 wherein the top and bottom sides of the plate are substantially planar.

14. The apparatus of claim 11 wherein the plate comprises metal.

15. A method of testing a liner assembly used to repair the junction of a main and lateral pipe, comprising:
forming a liner assembly comprising a main liner member having a main liner member opening and a lateral liner tube attached at and extending from the main liner member opening, the liners comprising a resin absorbent side and a coated side of an impermeable material;
positioning the resin absorbent side of the liner assembly on a top side of a tester comprising a plate with perforations therethrough and a negative pressure source operatively attached at a bottom side of the tester;
dispensing a colored liquid to the coated side of the liner assembly; and
viewing the resin absorbent side of the liner assembly to determine if the colored liquid has passed through to indicate a leak in the liner assembly.

16. The method of claim 15 wherein the lateral liner tube is attached to main liner member by a UV curing adhesive.

17. The method of claim 15 further comprising resealing the liner assembly at a leak if the test indicates that a leak exists.

18. The method of claim 17 further comprising repeating the test with a different colored liquid after resealing the liner assembly until no leaks exist in the liner assembly.

19. The method of claim 15 wherein the negative pressure source is a vacuum.

20. The method of claim 15 further comprising providing negative pressure at the tester for a period of time, and removing the negative pressure before viewing the resin absorbent side of the liner assembly.

21. A method of testing a liner tube formed by attaching two or more edges or surfaces of the liner tube to form a fluid tight seal, comprising:
providing a liner material having a resin absorbent side and a coated side of an impermeable material;
attaching at least two edges of the liner material to one another and sealing the edges along the length of the attachment to form a liner tube;
operatively positioning the liner tube on a tester adapted to provide a negative pressure to the liner tube, and providing said negative pressure;
dispensing a colored liquid to the coated side of the liner tube; and
viewing the resin absorbent side of the liner tube to determine if the colored liquid has passed through to indicate a leak in the liner tube.

22. The method of claim 21 further comprising resealing the edges of the liner tube at a leak if the test indicates that a leak exists.

23. The method of claim 22 further comprising repeating the test with a different colored liquid after resealing the liner tube until no leaks exist in the liner tube.

24. The method of claim 21 wherein the edges of the liner tube are attached to one another by flame bonding, stitching, gluing, or taping.
